(19) United States
(12) Patent Application Publication
(10) Pub. No.: US 2018/0260151 A1
(43) Pub. Date: Sep. 13, 2018

(54) Data Storage Device and Operating Method Therefor

(71) Applicant: Silicon Motion, Inc., Jhubei City (TW)

(72) Inventor: Sheng-I Hsu, Zhubei City (TW)

(73) Assignee: Silicon Motion, Inc.

(21) Appl. No.: 15/848,973

(22) Filed: Dec. 20, 2017

(30) Foreign Application Priority Data
Mar. 7, 2017 (TW) 106107356

(51) Int. Cl. G06F 3/06

(52) U.S. Cl. CPC G06F 3/0623; G06F 3/0638; G06F 3/0673

(57) ABSTRACT

A security mechanism for a data storage device. The data storage device includes a nonvolatile memory and a control unit. The control unit uses a dynamic random access memory at a host side with an encryption mechanism when operating the nonvolatile memory. The control unit protects keys of the encryption mechanism within the data storage device to isolate the keys from the host.

### CROSS REFERENCE TO RELATED APPLICATIONS

This Application claims priority of Taiwan Patent Application No. 106107356, filed on Mar. 7, 2017, the entirety of which is incorporated by reference herein.

### BACKGROUND OF THE INVENTION

### Field of the Invention

The present invention relates to data storage devices.

### Description of the Related Art

There are various forms of nonvolatile memory used in data storage devices for long-term data retention, such as flash memory, magnetoresistive RAM, ferroelectric RAM, resistive RAM, spin transfer torque-RAM (STT-RAM), and so on. How to protect nonvolatile memory from hacker attacks is an important issue in this area of technology.

### BRIEF SUMMARY OF THE INVENTION

A data storage device in accordance with an exemplary embodiment of the disclosure includes a nonvolatile memory and a control unit. The control unit performs an encryption mechanism on a dynamic random access memory of a host when operating the nonvolatile memory. The control unit protects keys of the encryption mechanism within the data storage device to isolate the keys from the host.

In another exemplary embodiment, a method for operating a data storage device is introduced which includes the following steps: performing an encryption mechanism on a dynamic random access memory of a host from a data storage device to operate a nonvolatile memory of the data storage device; and protecting keys of the encryption mechanism within the data storage device to isolate the keys from the host.

Because of the data encryption and the isolation of keys, valid data within the data storage device is protected from hackers attacking the host.

In an exemplary embodiment, an encryption and decryption module is provided within the data storage device. After being encrypted by the encryption and decryption module, host memory buffer data is transmitted to the host to be stored in the dynamic random access memory for temporary storage and waiting to be read back by the data storage device. The encryption and decryption module further decrypts the host memory buffer data read back from the dynamic random access memory of the host.

In an exemplary embodiment, a verification module is provided within the data storage device. When being read back from the dynamic random access memory of the host, the host memory buffer data is verified based on the verification code to determine whether or not the host memory buffer data has been tampered with by a hacker at the host. The verification code may be within the data storage device to isolate the verification code from the host. In another exemplary embodiment, the encryption and decryption module further encrypts the verification code to be transmitted to the host and stored in the dynamic random access memory for temporary storage with the host memory buffer data.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting a data storage device 100 in accordance with an exemplary embodiment of the disclosure;

FIG. 2A depicts data at the data storage device 100 side and the host 110 side in accordance with an exemplary embodiment of the disclosure;

FIG. 2B depicts the data at the data storage device 100 side and the host 110 side in accordance with another exemplary embodiment of the disclosure;

FIG. 3 shows a mapping table 300 depicting how the dynamic random access memory 114 at the host 110 side is utilized by the control unit 104;

FIG. 4 is a flowchart depicting a procedure that the data storage device 100 performs to write data into the dynamic random access memory 114; and

FIG. 5 is a flowchart depicting how the data in the dynamic random access memory 114 of the host 110 is read back to the data storage device 100.

### DETAILED DESCRIPTION OF THE INVENTION

The following description shows exemplary embodiments of carrying out the invention. This description is made for the purpose of illustrating the general principles of the invention and should not be taken in a limiting sense. The scope of the invention is best determined by reference to the appended claims.

To implement a data storage device, a nonvolatile memory, such as flash memory, a magnetoresistive RAM, a ferroelectric RAM, a resistive RAM, a spin transfer torque-RAM (STT-RAM) and so on, is introduced for long-term data retention. The following discussion uses flash memory in particular as an example, but it is not intended to be limited thereto.

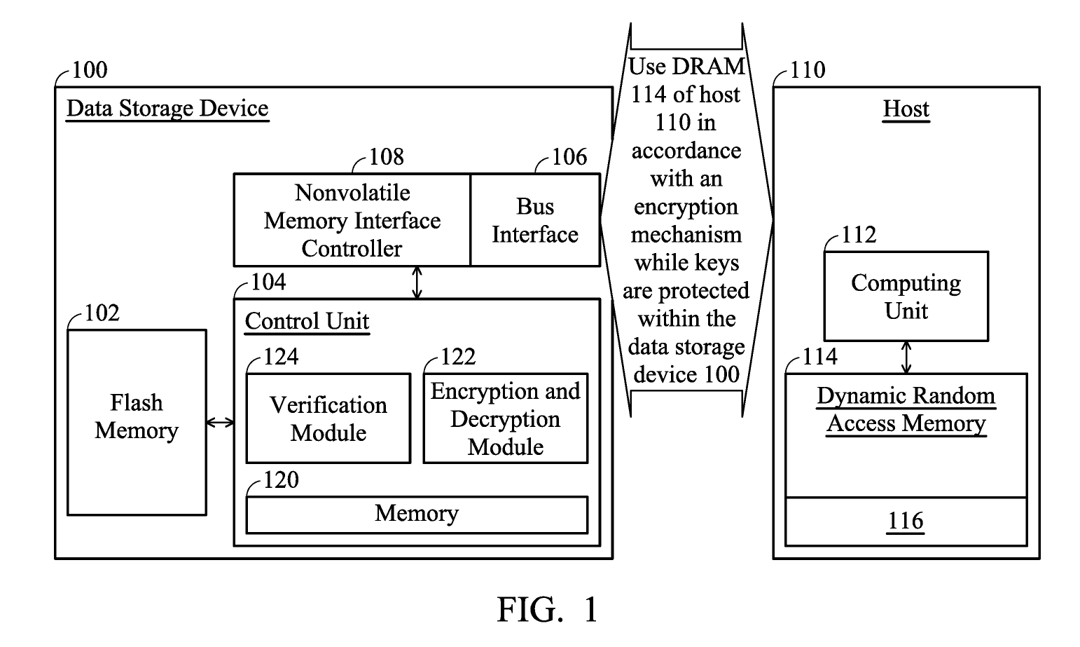

FIG. 1 is a block diagram depicting a data storage device 100 in accordance with an exemplary embodiment of the disclosure. The data storage device 100 includes a flash memory 102, a control unit 104, a bus interface 106, and a nonvolatile memory interface controller (e.g. an NVMe controller) 108. The data storage device 100 is connected to a host 110 via the bus interface 106. The bus interface 106 is controlled by the nonvolatile memory interface controller 108. The control unit 104 is coupled between the nonvolatile memory interface controller 108 and the flash memory 102 to operate the flash memory 102 according to instructions from the host 110.

The flash memory 102 has its own operational particularities. In an exemplary embodiment, the flash memory 102 has a plurality of physical blocks. Each physical block includes a plurality of physical pages. For example, one physical block may include 256 physical pages. Each physical page may be further divided into a plurality of memory cells. Each memory cell may be allocated to store data indicated by at least one logical block address (LBA). For example, one memory cell may store 4 KB of data which is indicated by eight logical block addresses LBAs (e.g. LBA#0-LBA#7). The mapping between the different memory cells of the flash memory 102 and the LBAs may be managed to form a table such as mapping table H2F. In an exemplary embodiment, mapping information is listed in mapping table H2F in order of LBA. In addition to mapping table H2F, other types of tables (or mapping tables) may be established by the user for management of the data stored in the flash memory 102 or to be used in rebuilding the mapping table H2F. In an exemplary embodiment, a mapping table F2H is established for a physical block to record the LBAs of data stored in the physical block. The mapping information is listed in mapping table F2H in order of physical pages or memory cells within the corresponding physical block. The mapping information aggregated from all F2H tables is a reversed version of mapping information recorded in the mapping table H2F. A large temporary storage space is required for the control unit 104 to store tables to manage the storage space of the flash memory 102.

When updating the data stored in the flash memory 102, the new data is written into a spare area rather than being rewritten over the storage space of the old data. The old data is invalidated. Frequent write operations issued by the host 110 flood the storage space of the flash memory 102 with invalid data, causing the flash memory 102 to be used ineffectively in data storage. A garbage collection operation is introduced to operate the flash memory 102 to process the physical blocks (i.e. source blocks) containing a lot of invalid data. Valid pages in source blocks are copied to destination blocks. Finally, only invalid pages are left in the source block, and the source blocks may be erased and thereby released. However, the storage reliability of a physical block may be damaged by the erase operations, affecting data retention. Furthermore, the flash memory 102 involves read disturbance issues. During a read operation, high voltages are applied to the word lines near the target word line, disturbing the data in the storage cells operated by the high-voltage word lines near the target word line. The reliability of the flash memory 102, therefore, is affected. In order to meet the requirements for the various physical properties of flash memory 102, a large space is required to store calculation data and program code when the control unit 104 operates the flash memory 102.

To accommodate the need for a large temporary storage space, an HMB (host memory buffer) technique is used in the disclosure.

Referring to FIG. 1, a computing unit 112 and a dynamic random access memory 114 are provided at the host 110 side. A space 116 is allocated in the dynamic random access memory 114 to meet the large temporary storage needs of the control unit 104 and the control unit 104 uses the space 116 in an encrypted mode. Specifically, the control unit 104 protects keys of the adopted encryption mechanism within the data storage device 100. For example, the keys may be protected in a hidden block, a confidential block, a ROM image, an in-system program, or an e-fuse within the flash memory 102. The keys are not transmitted to the host 110, nor are they stored in the space 116 of the dynamic random access memory 114. Any hacker who invades the host 110 and steals data from the space 116 of the dynamic random access memory 114 only gets garbled code and has no idea about the encryption/decryption keys. Thus, the data within the data storage device 100 is protected from being stolen by hackers.

As shown in FIG. 1, the control unit 104 has a memory 120, whose size may be much smaller than the space 116 allocated in the dynamic random access memory 114, considerably reducing the cost of the data storage device 100. The mapping information for allocating the dynamic random access memory 114 to provide the space 116 may be stored in the memory 120. In an exemplary embodiment, the memory 120 may be a static random access memory (SRAM). In some other exemplary embodiments, a dynamic random access memory that is much smaller than the space 116 is provided as the memory 120.

In FIG. 1, the control unit 104 further has an encryption and decryption module 122 for encryption of HMB (host memory buffer) data. After the encryption, the HMB data is transmitted to the host 110 to be stored in the space 116 of the dynamic random access memory. The encryption and decryption module 122 are further operative to decrypt the HMB data read from the space 116 of the dynamic random access memory 114 and transmitted back to the data storage device 100. In an exemplary embodiment, an advanced encryption standard (AES) is used in the encryption and decryption module 122. The encryption and decryption module 122 may be hardware or a combined design of hardware and software. In some exemplary embodiments, the user may adopt an asymmetric encryption and decryption mechanism (e.g. RSA) rather than the AES using symmetric keys. In some exemplary embodiments, both the AES and RSA mechanisms are adopted. Regarding the asymmetric encryption and decryption mechanism, the public key and the private key both are protected within the data storage device 100.

In FIG. 1, a verification module 124 is further provided by the control unit 104 to protect the space 116 of the dynamic random access memory 114 and prevent it from being tampered with by a hacker. The verification module 124 generates verification code for the HMB data that is going to be uploaded to the host 110 side. The verification code may be attached to the HMB data or be stored in the memory 120 of the data storage device 100. When the HMB data is read from the space 116 of the dynamic random access memory 114 and transmitted back to the data storage device 100, the verification module 124 reproduces the verification code and compares the reproduced verification code with the attached verification code returned to the data storage device 100 with the HMB data or the verification code read from the memory 120. By checking the verification code, it is determined whether or not the data read from the space 116 of the dynamic random access memory 114 of the host 110 has been tampered with. In an exemplary embodiment, a CRC (cyclic redundancy check) is used in the verification module 124. In another exemplary embodiment, a secure Hash algorithm (SHA) is used in the verification module 124. The verification module 124 may be hardware or a combined design of hardware and software.

The data storage device 100 may be used for implementation of a memory card, a USB flash device, an SSD, and so on. In another exemplary embodiment, the flash memory 102 is packaged with the control unit 104 to form an embedded Multi Chip Package (eMMC). A central processing unit (CPU) of a portable electronic device (e.g. a smartphone, a tablet and so on) may serve as the computing unit 112 shown in FIG. 1. Furthermore, a large dynamic random access memory (gigabits) and provided in the portable electronic device may serve as the dynamic random access memory 114 shown in FIG. 1. The large dynamic random access memory essential in the portable electronic device is allocated to provide the space 116 without dragging down system performance.

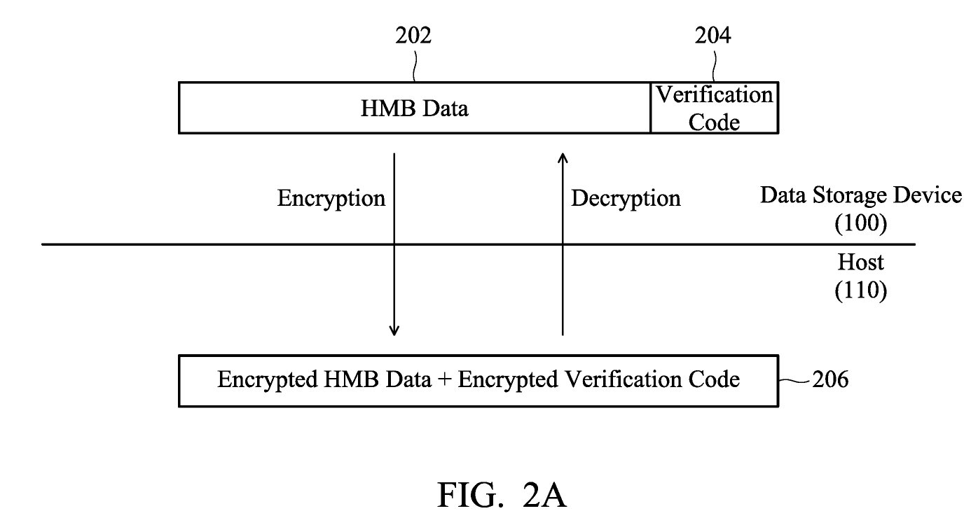

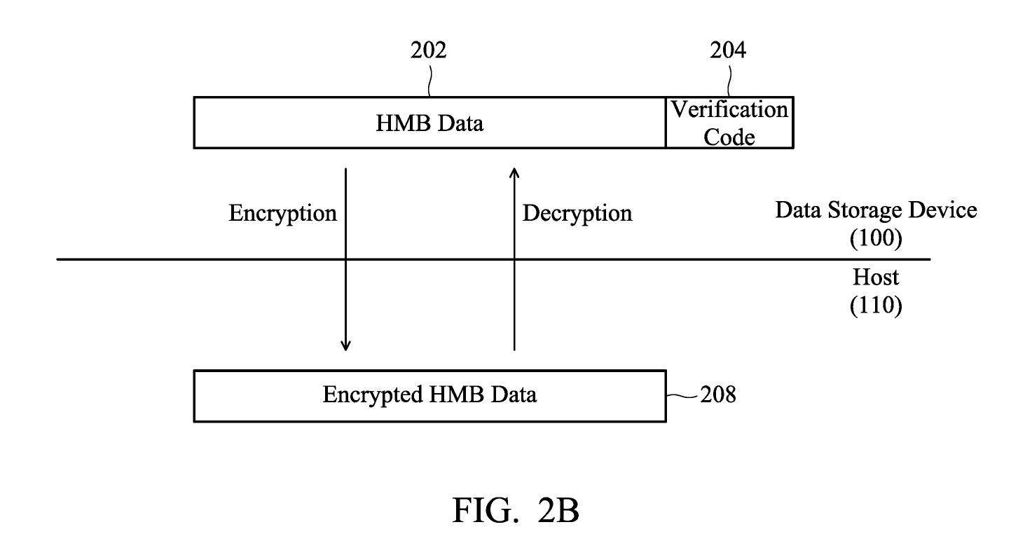

Regarding the HMB data to be temporarily stored in the space 116 of the dynamic random access memory 114 in the host 110 side, FIG. 2A depicts the data at the data storage device 100 side and the host 110 side in accordance with an exemplary embodiment of the disclosure. HMB data 202 may be mapping information listed in the aforementioned tables, or temporary calculation data or code for operating the flash memory 102. The verification module 124 generates the verification code 204 for the HMB data 202. In this exemplary embodiment, the encryption and decryption module 122 encrypts both the HMB data 202 and the verification code 204. As shown, data 206 including the encrypted data (corresponding to HMB data 202) and the encrypted verification code (corresponding to code 204) is transmitted to the host 110 to be temporarily stored in the space 116 of the dynamic random access memory 114. Because the keys for encryption/decryption are not available at the host 110 side, no meaning content can be obtained from the data 206 at the host 110 side. The decryption of the data 206 is performed by the encryption and decryption module 122 after the data 206 is read back from the host 110. Thus, the data decryption is protected within the data storage device 100 to prevent malicious attacks. The decrypted verification code (corresponding to code 204) is used to determine whether or not a hacker is attempting to tamper with the HMB data at the host 110 side.

Unlike FIG. 2A, FIG. 2B depicts the data at the data storage device 100 side and the host 110 side in accordance with another exemplary embodiment of the disclosure. In this exemplary embodiment, the encryption and decryption module 122 encrypts the HMB data 202 without encrypting the verification code 204. As shown, data 208 transmitted to the host 110 to be temporarily stored in the space 116 of the dynamic random access memory 114 does not include any information about the verification code 204. The verification code 204 is protected within the data storage device 100 and is prevented from being maliciously tampered with by a hacker at the host 110 side.

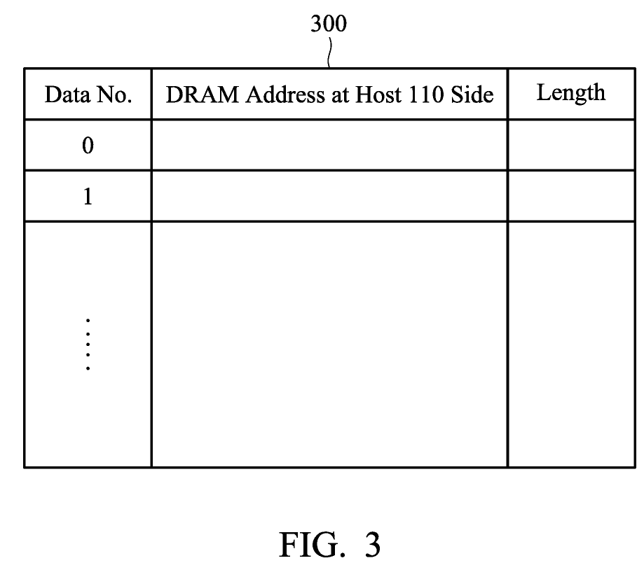

FIG. 3 shows a mapping table 300 depicting how the dynamic random access memory 114 at the host 110 side is utilized by the control unit 104. The control unit 104 may output a space allocation request to the host 110 and, accordingly, the computing unit 112 of the host 110 allocates the dynamic random access memory 114 to provide the space 116 for the control unit 104. The space 116 may be a continuous space or fragmented areas scattered over the dynamic random access memory 114. The control unit 104 may list mapping information about the space 116 in the mapping table 300 in order of data number to show the corresponding DRMA address and data length. Each sector of data with the mapping information listed in the mapping table 300 may correspond to a predetermined data size, e.g., 2 KB, 4 KB or 16 KB.

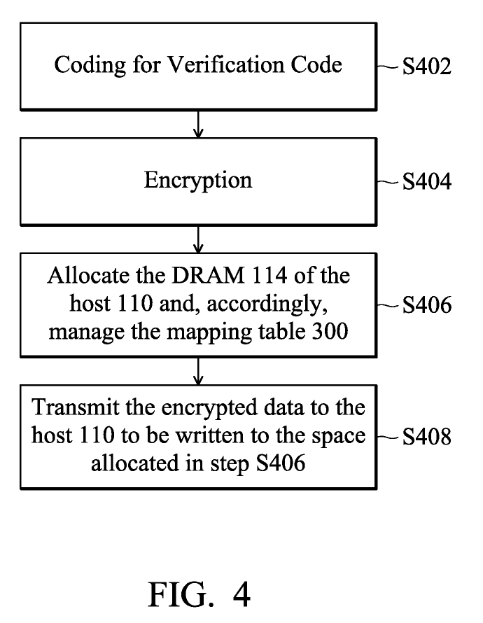

FIG. 4 is a flowchart depicting a procedure that the data storage device 100 performs to write data into the dynamic random access memory 114. In step S402, verification code is generated for HMB data. In step S404, an encryption process is performed. In step S406, allocation of the dynamic random access memory 114 of the host 110 is performed and the mapping table 300 is dynamically managed. In step S408, the data encrypted in step S404 is transmitted to the host 110 and written into the space allocated in step S406. The verification code generated in step S402 may be also encrypted and transmitted to the host 110 in steps S404 and S406 as illustrated in FIG. 2A, or it may be protected within the data storage device 100 as illustrated in FIG. 2B.

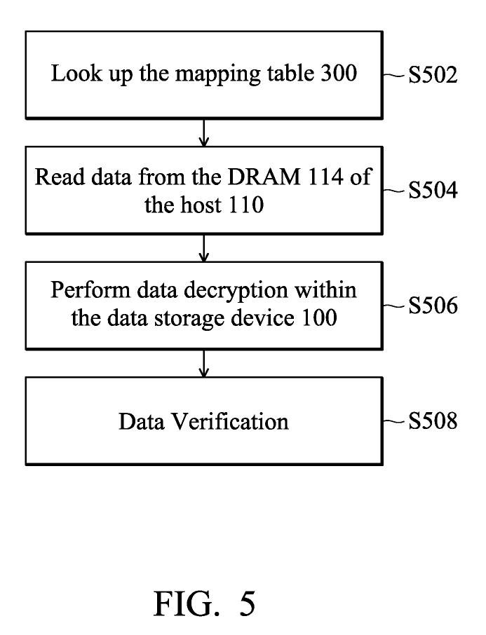

FIG. 5 is a flowchart depicting how the data in the dynamic random access memory 114 of the host 110 is read back to the data storage device 100. The mapping table 300 is consulted in step S502 and, accordingly, the encrypted data is read from the dynamic access memory 114 of the host 110 in the following step S504. In step S506, the encrypted data is decrypted within the data storage device 100. In step S508, data verification is performed. Referring to FIG. 2A, the verification code checking in step S508 involves checking the decrypted verification code. Referring to FIG. 2B, the checking of the verification code in step S508 involves checking the previously stored verification code.

It should be noted that data in the space 116 allocated in the dynamic random access memory 114 of the host 110 will be lost in the event of a power-off event. The control unit 104 may be configured to regularly access the space 116 of the dynamic random access memory 114 of the host 110 to copy data to the flash memory 102 for nonvolatile storage.

In an exemplary embodiment, the updated version of the firmware code of the data storage device 100 may be written into the flash memory 102 first and then downloaded to the space 116 of the dynamic random access memory 114 of the host 110 as HMB data to be executed by the control unit 104 for execution of the firmware code. The access speed at which the control unit 104 accesses the space 116 of the dynamic random access memory 114 of the host 110 may be guaranteed by the powerful nonvolatile memory interface controller 108.

Other techniques that use the aforementioned concepts to achieve the secure use of the dynamic random access memory at the host side are within the scope of the disclosure. Based on the above contents, the present invention further relates to methods for operating a data storage device.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a nonvolatile memory; and
a control unit, performing an encryption mechanism on a dynamic random access memory of a host when operating the nonvolatile memory,
wherein the control unit protects keys of the encryption mechanism within the data storage device to isolate the keys from the host.

2. The data storage device as claimed in claim 1, wherein:
the control unit includes an encryption and decryption module; and
after being encrypted by the encryption and decryption module, host memory buffer data is transmitted to the host by the control unit to be stored in the dynamic random access memory for temporary storage and waiting to be read back by the control unit.

3. The data storage device as claimed in claim 2, wherein:
the control unit further uses the encryption and decryption module to decrypt the host memory buffer data read back from the dynamic random access memory of the host.

4. The data storage device as claimed in claim 3, wherein:
the control unit further comprises a verification module that generates verification code for the host memory buffer data; and
when being read back from the dynamic random access memory of the host, the host memory buffer data is verified based on the verification code to determine whether or not the host memory buffer data has been tampered with by a hacker at the host.

5. The data storage device as claimed in claim 4, wherein:
the control unit protects the verification code within the data storage device to isolate the verification code from the host.

6. The data storage device as claimed in claim 4, wherein:
the encryption and decryption module further encrypts the verification code to be transmitted to the host and stored in the dynamic random access memory for temporary storage with the host memory buffer data.

7. The data storage device as claimed in claim 6, wherein:
the encryption and decryption module further decrypts the verification code read back from the dynamic random access memory of the host; and
the verification module verifies the host memory buffer data decrypted by the encryption and decryption module based on the verification code decrypted by the encryption and decryption module.

8. The data storage device as claimed in claim 3, wherein:
the control unit outputs a space allocation request to request the host to allocate the dynamic random access memory to provide a space for temporary storage of the host memory buffer data.

9. The data storage device as claimed in claim 8, further comprising a memory, wherein the control unit manages a mapping table in the memory for use of the dynamic random access memory of the host.

10. The data storage device as claimed in claim 3, wherein:
the nonvolatile memory is a flash memory;
the host memory buffer data is mapping information between the flash memory and logical block addresses used by the host or firmware code for operations of the control unit;
the control unit uses the dynamic random access memory of the host to manage the mapping information and the mapping information managed on the dynamic random access memory of the host is read back and stored in the flash memory by the control unit; and
the control unit transmits the firmware code to the host to be stored in the dynamic random access memory after loading the firmware code into the flash memory.

11. A method for operating a data storage device, comprising:
performing an encryption mechanism on a dynamic random access memory of a host from a data storage device to operate a nonvolatile memory of the data storage device; and
protecting keys of the encryption mechanism within the data storage device to isolate the keys from the host.

12. The method as claimed in claim 11, further comprising:
providing an encryption and decryption module within the data storage device,
wherein after being encrypted by the encryption and decryption module, host memory buffer data is transmitted to the host to be stored in the dynamic random access memory for temporary storage and waiting to be read back to the data storage device.

13. The method as claimed in claim 12, further comprising:
using the encryption and decryption module to decrypt the host memory buffer data read back from the dynamic random access memory of the host.

14. The method as claimed in claim 13, further comprising:
providing a verification module on the data storage device to generate verification code for the host memory buffer data,
wherein when being read back from the dynamic random access memory of the host, the host memory buffer data is verified based on the verification code to determine whether or not the host memory buffer data has been tampered with by a hacker at the host.

15. The method as claimed in claim 14, further comprising:
protecting the verification code within the data storage device to isolate the verification code from the host.

16. The method as claimed in claim 14, further comprising:
using the encryption and decryption module to encrypt the verification code to be transmitted to the host and stored in the dynamic random access memory for temporary storage with the host memory buffer data.

17. The method as claimed in claim 16, wherein:
the encryption and decryption module further decrypts the verification code read back from the dynamic random access memory of the host; and
the verification module verifies the host memory buffer data decrypted by the encryption and decryption module based on the verification code decrypted by the encryption and decryption module.

18. The method as claimed in claim 13, further comprising:
outputting a space allocation request from the data storage device to request the host to allocate the dynamic random access memory to provide a space for temporary storage of the host memory buffer data.

19. The method as claimed in claim 18, further comprising:
providing a memory within the data storage device; and
managing a mapping table in the memory to use the dynamic random access memory of the host from the data storage device.

20. The method data as claimed in claim 13, wherein:
the nonvolatile memory is a flash memory;
the host memory buffer data is mapping information between the flash memory and logical block addresses used by the host or firmware code of the data storage device;
the mapping information between the flash memory and the logical block memory of the host to be read back and stored in the flash memory by the control unit; and
the firmware code is transmitted to the host to be stored in the dynamic random access memory after being loaded into the flash memory.
